(19) United States
(12) Patent Application Publication
(10) Pub. No.: US 2026/0038730 A1
(43) Pub. Date: Feb. 5, 2026

(54) GAPLESS MAGNETIC COUPLING CONTROL

(71) Applicant: Nanowatt Inc., Milpitas, CA (US)

(72) Inventors: Owen Jong, Milpitas, CA (US); Ya Liu, Milpitas, CA (US)

(21) Appl. No.: 18/794,158

(22) Filed: Aug. 5, 2024

(51) Int. Cl. H01F 27/28; H01F 27/00; H01F 27/34; H01F 38/14

(52) U.S. Cl. CPC H01F 27/2823; H01F 27/006; H01F 27/34; H01F 38/14

(57) ABSTRACT

A device includes at least one magnetic material including a top plane, a bottom plane, and at least three legs that are directly coupled to the top and bottom planes to define first, second, third, and fourth portions of the at least one magnetic material and to form two gapless magnetic circuits. The device also includes a first wire including a first section wound around the first portion and a third section wound around the third portion, and a second wire including a second section wound around the second portion and a fourth section wound around the fourth portion. When current flows through the first and second wires, a degree of electromagnetic coupling, based on interactions with the magnetic material, between the first and second wires is based on a first number of windings of the first section over a second number of windings of the second section.

### TECHNICAL FIELD

The present disclosure is directed to gapless devices for controlling magnetic flux coupling. In some embodiments, a device includes at least two gapless magnetic circuits.

### BACKGROUND

Certain electronic devices (e.g., transformers and coupled inductors) operate based on electromagnetic coupling between at least two wires. The performance of such devices may depend on the properties of the electromagnetic coupling.

### SUMMARY

In accordance with the present disclosure, gapless devices and corresponding circuitry are disclosed for controlling magnetic flux coupling. The devices disclosed herein may control the degree of electromagnetic coupling that occurs between at least two wires. The corresponding circuitry may incorporate the devices to execute power transfer operations.

In accordance with some embodiments of the present disclosure, a device includes at least one magnetic material including a top plane, a bottom plane, and at least three legs, all of which are directly coupled to the top plane and to the bottom plane to define a first portion, a second portion, a third portion, and a fourth portion of the at least one magnetic material and to form two gapless magnetic circuits. The device also includes a first wire including a first section wound around the first portion and a third section wound around the third portion, and a second wire including a second section wound around the second portion and a fourth section wound around the fourth portion, such that when a current flows through the first wire and the second wire, a degree of electromagnetic coupling, based on interactions with the at least one magnetic material, between the first wire and the second wire is based on at least a ratio of a first number of windings of the first section over a second number of windings of the second section.

In some embodiments, the degree of the electromagnetic coupling is further based on a ratio of a fourth number of windings of the fourth section over a third number of windings of the third section.

In some embodiments, the first section and the second section are arranged as a first transformer, and the third section and the fourth section are arranged as a second transformer.

In some embodiments, the first transformer and the second transformer are electromagnetically equivalent to a coupled inductor, and the degree of electromagnetic coupling is further based on an inductance of the first wire and an inductance of the second wire.

In some embodiments, the at least one magnetic material includes a first magnetic material and a second magnetic material, where the first magnetic material includes the first portion and the second portion and the second magnetic material includes the third portion and the fourth portion.

In some embodiments, the at least one magnetic material includes a single magnetic material, where each of the two gapless magnetic circuits includes at least one portion of the top plane, at least one portion of the bottom plane, and exactly two of the three legs.

In some embodiments, the three legs include a center leg arranged between first and second legs, where when the current flows through the first wire and the second wire, the center leg cancels magnetic flux of a first magnetic circuit of the two gapless magnetic circuits with magnetic flux of a second magnetic circuit of the two gapless magnetic circuits.

In some embodiments, the at least one magnetic material further includes a fifth portion and a sixth portion, the device further including a third wire including a fifth section wound around the fifth portion, and a sixth section wound around the sixth portion.

In some embodiments, the degree of electromagnetic coupling, based on interactions with the at least one magnetic material, between the first wire and the third wire is based on at least a ratio of the third number of windings over the fifth number of windings.

In some embodiments, the degree of electromagnetic coupling, based on interactions with the at least one magnetic material, between the second wire and the third wire is based on at least a ratio of the fourth number of windings over the sixth number of windings.

In some embodiments, the first wire and the second wire are arranged such that when the current flows through the first wire and the second wire, a direction of the current flow through the first portion opposes a direction of the current flow through the second portion, and a direction of the current flow through the third portion opposes a direction of the current flow through the fourth portion.

In some embodiments, the first wire and the second wire are arranged such that when the current flows through the first wire and the second wire, a direction of the current flow through the first section aligns with a direction of the current flow through the second portion, and a direction of the current flow through the third portion opposes a direction of the current flow through the fourth portion.

In accordance with some embodiments of the present disclosure, a device includes a magnetic material including a top plane including a first primary side, a second primary side, and a third primary side, a bottom plane including corresponding first, second, and third primary sides, and three legs, all of which are directly coupled to the top plane and to the bottom plane to form two gapless magnetic circuits, where a first leg of the at least three legs extends from a junction between the first primary side and the second primary side, a second leg of the at least three legs extends from a junction between the first primary side and the third primary side, and a third leg of the at least three legs extends from a junction between the second primary side and the third primary side. The device also includes a first wire including a first section wound around the first leg, and a second wire including a second section wound around the second leg, such that when current flows through the first wire and the second wire, a degree of electromagnetic coupling, based on interactions with the at least one magnetic material, between the first wire and the second wire is based on at least a ratio of a first number of windings of the first section over a second number of windings of the second section.

In some embodiments, the first, second, and third legs are arranged such that when the current flows through the first wire and the second wire, the first leg and the second leg cancel magnetic flux of a first magnetic circuit of the two gapless magnetic circuits with magnetic flux of a second magnetic circuit of the two gapless magnetic circuits.

In some embodiments, the device also includes a third wire including a third section wound around the first leg and the second leg, such that when current flows through the first wire, the second wire, and the third wire, a degree of electromagnetic coupling, based on interactions with the at least one magnetic material, between the first wire and the third wire is based on at least a ratio of the first number of windings of the first section over a third number of windings of the third section, and a degree of electromagnetic coupling, based on interactions with the at least one magnetic material, between the second wire and the third wire is based on at least a ratio of the second number of windings of the second section over the third number of windings of the third section.

In accordance with some embodiments of the present disclosure, a coupled inductor plus inductor voltage regulator (CLVR) circuit is configured for N phases of operation, where N is an even integer greater than 1. The circuit includes at least N/2 magnetic materials, where at least two wires are wound around each of the magnetic materials. Each of the magnetic materials includes a top plane, a bottom plane, and at least three legs, all of which are directly coupled to the top plane and to the bottom plane to define a first portion, a second portion, a third portion, and fourth portion of the magnetic material and to form two gapless magnetic circuits. The circuit also includes a first wire of the at least two wires, the first wire including a first section wound around the first portion and a third section wound around the third portion, and a second wire of the at least two wires, the second wire including a second section wound around the second portion and a fourth section wound around the fourth portion.

In some embodiments, respective outputs of the third section and the fourth section are coupled to each other and are coupled to a load.

In some embodiments, the circuit also includes multiple switches to control current flows through the at least two wires.

In some embodiments, the at least one magnetic material further includes a fifth portion and a sixth portion, and the circuit also includes a third wire of the at least two wires, the third wire including a fifth section wound around the fifth portion and a sixth section wound around the sixth portion.

In some embodiments, the circuit also includes a coupling inductor, where: the first section and the second section are electromagnetically equivalent to a first transformer, respective outputs of the third section and the fourth section are coupled to each other and to a load, and respective outputs of the fifth section and the sixth section are coupled to the coupling inductor.

### BRIEF DESCRIPTION OF THE DRAWINGS

The following description includes discussion of figures having illustrations given by way of example of implementations of embodiments of the disclosure. The drawings should be understood by way of example, and not by way of limitation. As used herein, references to one or more “embodiments” are to be understood as describing a particular feature, structure, and/or characteristic included in at least one implementation. Thus, phrases such as “in some embodiments” appearing herein describe at least one embodiment and implementation, and do not necessarily all refer to the same embodiment. However, they are also not necessarily mutually exclusive.

FIG. 1 shows a cross-sectional view of an illustrative first magnetic flux coupling device, in accordance with some embodiments of the present disclosure.

FIG. 2 shows a cross-sectional view of an illustrative second magnetic flux coupling device, in accordance with some embodiments of the present disclosure.

FIG. 3 shows front, back, and side views of a possible implementation of the first magnetic flux coupling device, in accordance with some embodiments of the present disclosure.

FIG. 4 shows equivalent circuit schematics associated with at least the first or second magnetic flux coupling devices, in accordance with some embodiments of the present disclosure.

FIG. 5 shows a power converter circuit schematic including a magnetic flux coupling device, in accordance with some embodiments of the present disclosure.

FIG. 6A shows a cross-sectional view of an illustrative third magnetic flux coupling device, in accordance with some embodiments of the present disclosure.

FIG. 6B shows front, back, and side views of the illustrative third magnetic flux coupling device, in accordance with some embodiments of the present disclosure.

FIG. 7 shows a power converter circuit schematic associated with the third magnetic flux coupling device, in accordance with some embodiments of the present disclosure.

FIG. 8 shows a cross-sectional view of an illustrative fourth magnetic flux coupling device, in accordance with some embodiments of the present disclosure.

FIG. 9 shows a cross-sectional view of an illustrative fifth magnetic flux coupling device, in accordance with some embodiments of the present disclosure.

FIG. 10 shows perspective and cutout views of the illustrative fifth magnetic flux coupling device, in accordance with some embodiments of the present disclosure.

FIG. 11A shows a cross-sectional view of an illustrative sixth magnetic flux coupling device, in accordance with some embodiments of the present disclosure.

FIG. 11B shows perspective and cutout views of the illustrative sixth magnetic flux coupling device, in accordance with some embodiments of the present disclosure.

FIG. 12 shows an equivalent circuit corresponding to a magnetic flux coupling device that uses a transformer to control magnetic flux coupling, in accordance with some embodiments of the present disclosure.

FIG. 13 shows an equivalent circuit corresponding to a magnetic flux coupling device that operates as a step down transformer, in accordance with some embodiments of the present disclosure.

### DETAILED DESCRIPTION

Transformers, coupled inductors, and other related electronic devices may be used for power conversion applications. In these electronic devices, the degree of electromagnetic coupling between discrete components of the devices affects how these devices perform, as well as the related power conversion operation. As used herein, the degree of electromagnetic coupling refers to how much current develops in a second wire based on magnetic flux caused by current flowing through a first wire. In transformers and coupled inductors, the first and second wires may each be wound around a single magnetic material, such that current flowing through the first wire induces magnetic flux in the material, and this magnetic flux induces current to flow through the second sire (or vice versa).

The degree of electromagnetic coupling may be controlled in various ways. In some embodiments, the degree of electromagnetic coupling may be controlled at least in part by using a magnetic material with a gap. For example, the size of the gap may at least partially determine how much magnetic flux flows between respective wires. However, it may be difficult to precisely tune the degree of electromagnetic coupling based on having to precisely tune the size and/or geometry of a gap.

In accordance with embodiments of the present disclosure, at least two wires are each wound around respective portions of one or more magnetic material, where the one or more magnetic material includes at least two gapless magnetic circuits (e.g., loops through which magnetic flux can travel). Based on this arrangement, multiple possible magnetic flux coupling devices are provided for precise control over the degree of electromagnetic coupling between the at least two wires. In some embodiments, a coupled inductor plus voltage regulator (CLVR) circuit is provided for power conversion. The CLVR circuit is configured for an even number of phases of operation and, due to including the magnetic flux coupling devices described in this disclosure, requires a total number of magnetic materials that is equal to half of the number of phases of operation.

FIG. 1 shows a cross-sectional view of an illustrative first magnetic flux coupling device 100, in accordance with embodiments of the present disclosure. The device includes a single magnetic material 102 including a top plane 112, a bottom plane 114, and at least three legs (e.g., first leg 116, center leg 118, and second leg 120), each of which is directly coupled (e.g., at respective top and bottom surfaces) to the top plane 112 and the bottom plane 114. Based on how these those legs connect to those two planes, at least four portions of the magnetic material are defined and at least two gapless magnetic circuits are defined. In some embodiments, the four portions include first portion 104, second portion 106, third portion 108, and fourth portion 110; in other embodiments, any four discrete portions may be chosen, so long as the four portions form any two gapless magnetic circuits. As used herein, a magnetic circuit is gapless when the magnetic material of the circuit has a continuous geometry that forms a closed loop through which magnetic flux can circulate. As shown in FIG. 1, each of the two gapless magnetic circuits may include at least one portion of the top plane, at least one portion of the bottom plane, and exactly two of the three legs.

As shown in FIG. 1, the four aforementioned portions form a first gapless magnetic circuit including flux lines 135A-D (e.g., as are associated with a first wire, as described below) and flux lines 145A-E (e.g., as are associated with a first wire, as described below), and a second gapless magnetic circuit including flux lines 135D-J (e.g., as are associated with the first wire) and flux lines 145E-J (e.g., as are associated with the second wire). The respective flux lines are shown as dashed in connection with the first wire and as solid in connection with the second wire. Current flowing through the first and second wire causes the magnetic flux lines to develop because of how magnetic flux induced by the moving charge couples to the magnetic material.

The first magnetic flux coupling device 100 also includes a first wire 130, including a first section 130A wound around the first portion 104, and a third section 130B wound around the third portion 108. The first magnetic flux coupling device 100 also includes a second wire 140 including a second section 140A wound around the second portion 106 and a fourth section 140B wound around the fourth portion 110. As shown, the first section 130A is wound around the first portion 104 one time, the second section 140A is wound around the second portion 106 two times, the third section 130B is wound around the third portion 108 two times, and the fourth section 140B is wound around the fourth portion 110 one time. This number of windings is merely illustrative, and any suitable number of windings may be used at least to control the degree of electromagnetic coupling, as further described below.

The first wire 130 is represented by a dashed circle and the second wire 140 is represented by a solid circle. Within these circles, ‘x’ and ‘o’ represent directions of current flow, where ‘x’ represents current flow oriented from the front (e.g., visible side) of device 100 to the back (e.g., hidden side) of the device (e.g., into the page), and ‘o’ represents current flow oriented from the back of the device to the front of the device (e.g., out of the page). These current flow directions can also be derived from the corresponding magnetic flux lines using the right-hand rule. Accordingly, the first wire 130 and the second wire 140 are arranged such that when current flows through the first wire and the second wire, a direction of the current flow through the first section 130A opposes a direction of the current flow through the second section 140A, and a direction of the current flow through the third section 130B opposes a direction of the current flow through the fourth section 140B.

Based on the induced magnetic flux through the magnetic material 102, when a current flows through the first wire 130 and the second wire 140, a degree of electromagnetic coupling, based on interactions with the at least one magnetic material, between the first wire and the second wire is based on at least a ratio of a first number of windings (e.g., which is shown as one winding in FIG. 1) of the first section 104 over a second number of windings (e.g., which is shown as two windings in FIG. 1) of the second section 106. In some embodiments, the degree of the electromagnetic coupling is further based on a ratio of a fourth number of windings (e.g., which is shown as one winding in FIG. 1) of the fourth section 110 over a third number of windings (e.g., which is shown as two windings in FIG. 1) of the third section 108. Relatedly, the number of flux lines 135 and 145 flowing through each gapless magnetic circuit corresponds to the number of times that each wire section is wound around the corresponding portion of the respective gapless magnetic circuit.

As shown in FIG. 1, the three legs of first magnetic flux coupling device 100 include a center leg 118 arranged between the first leg 116 and the second leg 120. Thus, the center leg 118 of first magnetic flux coupling device 100 is part of both of the two gapless magnetic circuits. As a result, when current flows through the first wire and/or the second wire, the center leg 118 cancels magnetic flux of the first gapless magnetic circuit with magnetic flux of the second magnetic circuit. To illustrate, note that in the absence of any cancellation, the first gapless magnetic circuit would contribute one upward-facing dashed flux line (e.g., in connection with flux lines 135A-C) and two downward-facing solid flux lines (e.g., in connection with flux lines 145A-D and 145F-G), while the second gapless magnetic circuit would contribute two downward-facing dashed flux lines (e.g., in connection with flux lines 135E-J) and one upward-facing solid flux line (e.g., in connection with flux lines 145H-J). Yet due to the cancellation, the net flux as shown is equal to one downward-facing solid flux line (e.g., flux line 145E) and one downward-facing dashed flux line (e.g., flux line 135D).

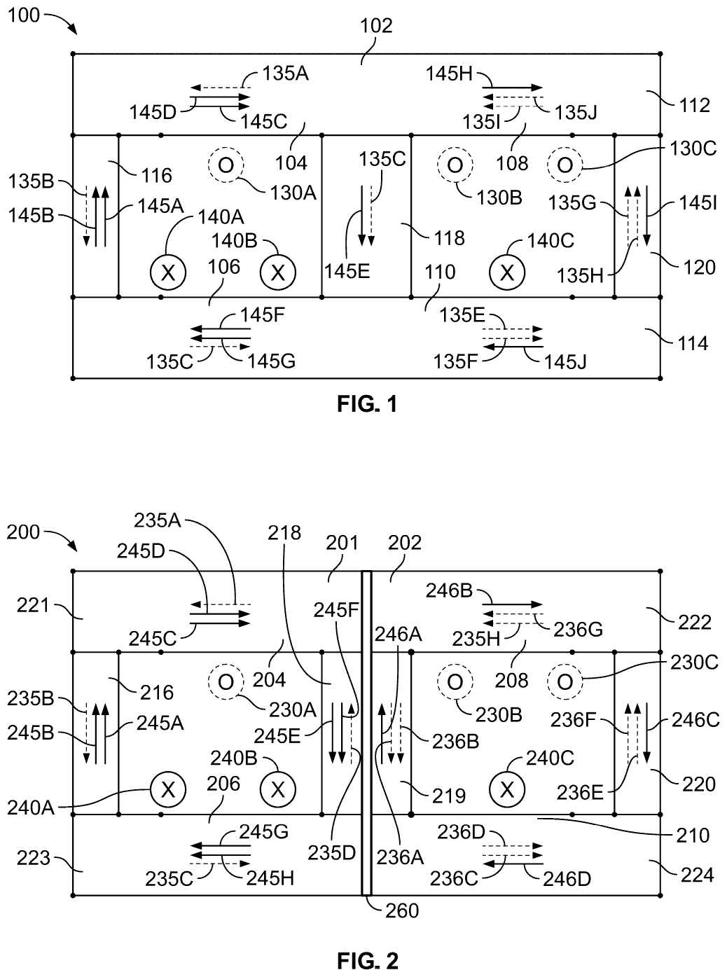

FIG. 2 shows a cross-sectional view of an illustrative second magnetic flux coupling device 200, in accordance with embodiments of the present disclosure. The second magnetic device 200 is similar to the first magnetic flux coupling device 100, except the former includes two magnetic materials 201 and 202 (e.g., separated by any suitable partition 260). The first magnetic material 201 includes the first portion 204 and the second portion 206, and the second magnetic material includes the third portion 208 and the fourth portion 210 which, aside from being distributed across the two magnetic materials, may otherwise correspond to first portion 104, second portion 106, third portion 108, and fourth portion 110, respectively. Similarly, first wire 230 may correspond to first wire 130 (including sections A and B thereof), second wire 240 may correspond to second wire 240 (including sections A and B thereof), first leg 216 may correspond to first leg 116, and second leg 220 may correspond to second leg 120.

Because the second magnetic flux coupling device 200 has two magnetic materials, there is no magnetic flux cancellation (e.g., as occurred in center leg 118). Therefore, each of the two gapless magnetic circuits shown in FIG. 2 has consistent magnetic flux through all regions of the magnetic circuits. The first magnetic circuit of magnetic flux coupling device 200 includes the first top portion 221, the first center leg 218, the first bottom portion 223, and the first outer leg 216. The second magnetic circuit of magnetic flux coupling device 200 includes the second top portion 222, the second center leg 219, the second bottom portion 224, and the second outer leg 220. Aside from the lack of flux cancellation and the correspondingly different configuration of the two gapless magnetic circuits, the other aspects of flux lines 235, 236, 245, and 246, as well as the current directions and number of windings associated with respective sections of the first wire 230 and the second wire 240, are generally consistent across first magnetic flux coupling device 100 and second magnetic flux coupling device 200.

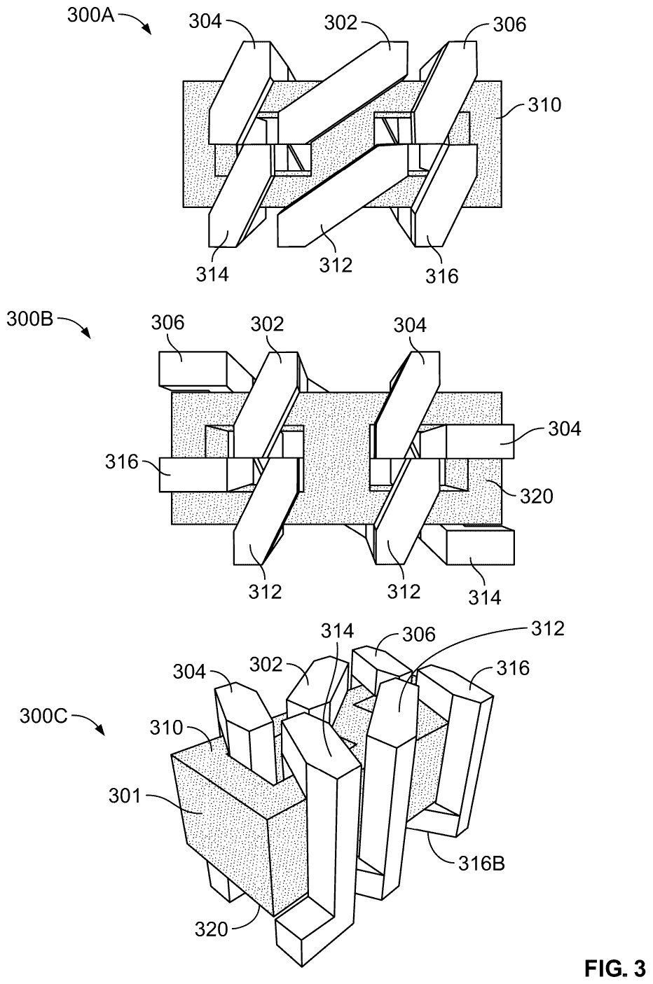

FIG. 3 shows front 300A, back 300B, and side 300C views of a possible

implementation of first magnetic flux coupling device 100, in accordance with embodiments of the present disclosure. It is noted that corresponding views of second magnetic flux coupling device 200 would look similar, except for having a partition 260 (e.g., which would extend at least between wire sections 302 and 312).

In FIG. 3, front view 300A shows a front side 310 of magnetic material 301 (e.g., which may correspond to magnetic material 102), a second wire (e.g., second wire 140) including sections 302, 304, and 306, and a first wire (e.g., first wire 130) including sections 312, 314, and 316. In some embodiments, section 304 and a portion of section 302 may correspond to section 140A; section 306 may correspond to section 140B; section 314 may correspond to section 130A; and section 316 and a portion of section 312 may correspond to section 130B. Sections 302 and 304 are wound around a first portion (e.g., first portion 104) of the magnetic material, section 306 is wound around a third portion (e.g., third portion 108) of the magnetic material, section 314 is wound around a second portion (e.g., second portion 106) of the magnetic material, and sections 312 and 316 are wound around a fourth portion (e.g., fourth portion 110) of the magnetic material.

In FIG. 3, back view 300B and side view 300C show additional details of the sections and portions described in connection with front view 300A and the cross-sectional view of FIG. 1. Back view 300B shows a back side 320 of the magnetic material, which reveals how wire sections 304, 306, 314, and 316 can provide connections (e.g., input and output connections) to first wire 130 and second wire 140 of magnetic flux coupling device 100. For example, additional sections of the first and second wires, though not being shown, may extend from the ends of sections 304, 306, 314, and 316 as shown. For another example, the ends of these sections may couple to pins (e.g., of a circuit board), and input/output wires may then couple to the magnetic flux coupling device through the pins. Side view 300C shows how sections 314, 312, and 316 of the second wire wrap around magnetic material 301 through the respective windows that are enclosed and defined by the first and second gapless magnetic circuits of the magnetic material.

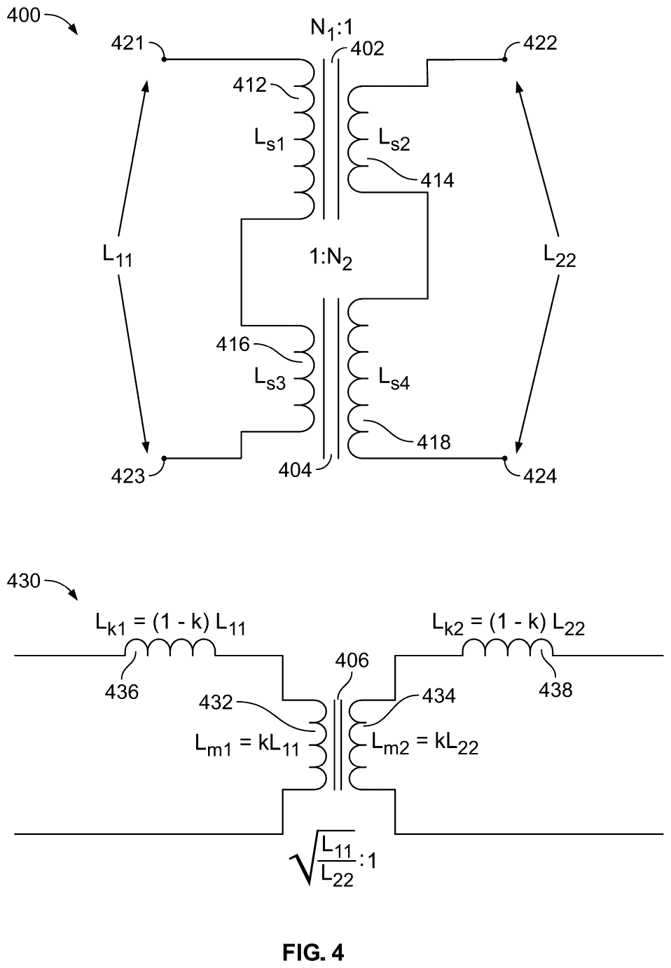

FIG. 4 shows equivalent circuit schematics associated with at least the first or second magnetic flux coupling devices, in accordance with embodiments of the present disclosure. Circuit schematic 400 shows a first equivalent circuit. This circuit schematic 400 includes a first wire (e.g., first wire 130), which spans terminals 421 to 423, and a second wire (e.g., second wire 140), which spans terminals 422 to 424. Each wire includes a pair of windings, which are labeled based on the corresponding inductances. These inductances include Lₛ₁, which is associated with the first section 412 (e.g., corresponding to first section 130A), Lₛ₃, which is associated with the third section 416 (e.g., corresponding to third section 130B), Lₛ₂, which is associated with the second section 414 (e.g., corresponding to second section 140A), and Lₛ₄, which is associated with the fourth section 418 (e.g., corresponding to fourth section 140B). As used below, inductances Lₛ₁ and Lₛ₃ may be lumped together as L₁₁ (e.g., an inductance of the first wire), and inductances Lₛ₁ and Lₛ₃ may be lumped together as L₂₂ (e.g., an inductance of the second wire). These inductances depend at least on the properties of the magnetic material (e.g., magnetic material 102 or related embodiments thereof) and the number of windings (e.g., which are represented by N₁ and N₂, as further described below) of each wire section around the magnetic material, as well as the possible magnetic flux cancellation that can occur between the two gapless magnetic circuits.

The vertical lines 402 and 404 represent magnetic coupling (e.g., due to the magnetic properties of first magnetic material 201 and second magnetic material 202, or due to each of the two gapless magnetic circuits of magnetic material 102) that occurs between the first and second wires. These magnetic couplings are based on the turns ratios N₁:1 and 1:N₂, which respectively describe the number of times section 412 is wound around magnetic material 402 over the number of times section 414 is wound around magnetic material 402, and the number of times section 418 is wound around magnetic material 404 over the number of times section 416 is wound around magnetic material 404. It is noted that “1” in the aforementioned ratios does not necessarily mean a single turn; rather, it means that when providing a certain degree of electromagnetic coupling, N₁ and N₂ are described as a multiple of the other number of turns.

As shown in circuit schematic 400, the first section 412 and the second section 414 are arranged as a first transformer, and the third section 416 and the fourth section 418 are arranged as a second transformer. As shown in circuit schematic 400 and elsewhere, the placement of two dots on either side of a transformer indicates a polarity of the power transfer across the transformer; dots being arranged on the same sides of the two respective windings indicates that a polarity is maintained (e.g., there is no phase shift) through a power transfer operation across the transformer, and dots being arranged on opposite sides of the two respective windings indicates that a polarity is reversed (e.g., there is a 180-degere phase shift) through a power transfer operation across the transformer.

As shown in circuit schematic 400, the first section 412 and the second section 414 are arranged as a first transformer, and the third section 416 and the fourth section 418 are arranged as a second transformer. As shown in circuit schematic 400 and elsewhere, the placement of two dots on either side of a transformer indicates a polarity of the power transfer across the transformer; dots being arranged on the same sides of the two respective windings indicates that a polarity is maintained through a power transfer operation across the transformer.

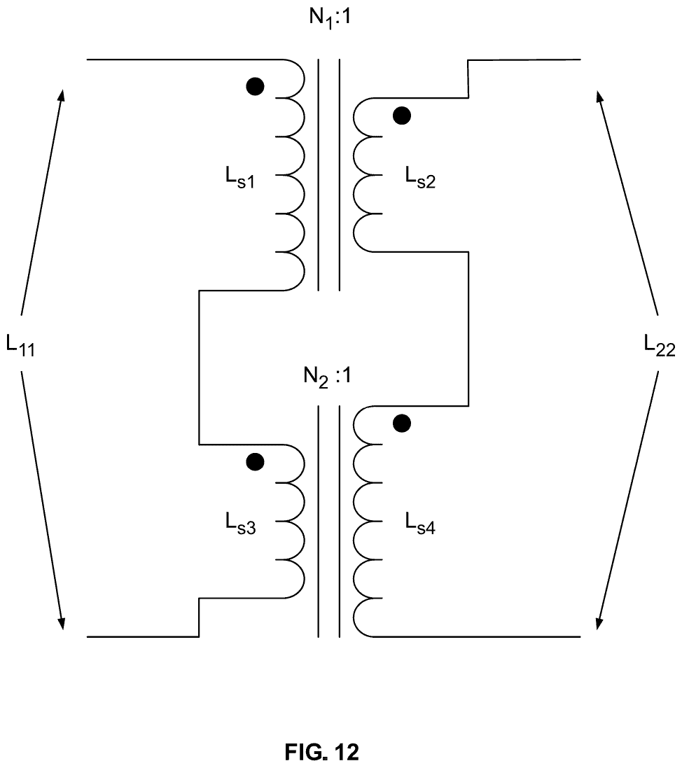

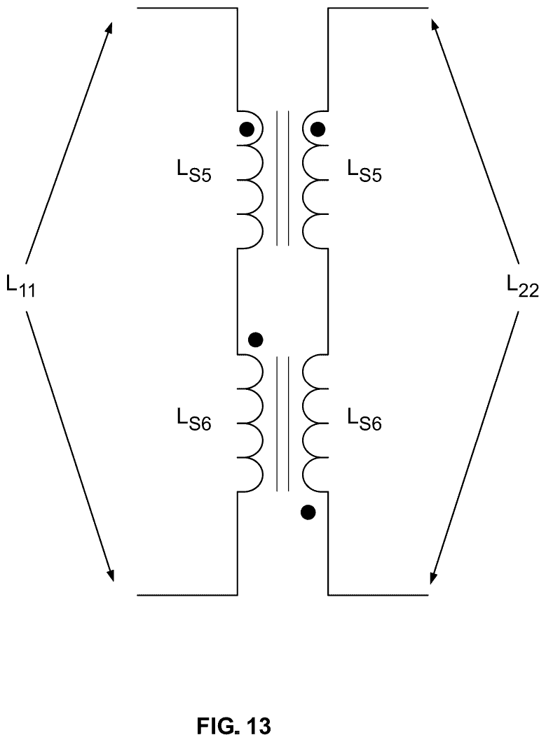

Circuit schematic 430 shows a second equivalent circuit associated with at least the first or second magnetic flux coupling devices. Circuit schematic 430 is equivalent to circuit schematic 400, showing how the aforementioned first transformer and the second transformer are electromagnetically equivalent to a coupled inductor. In some embodiments, circuit schematic 430 is also equivalent to the related embodiments of FIGS. 12 and 13. The degree of electromagnetic coupling across the coupled inductor is equal to

$$\sqrt{\frac{{L}_{11}}{{L}_{22}}} : 1 ,$$

such that the degree of electromagnetic coupling is based on an inductance of the first wire and an inductance of the second wire.

To further characterize the coupled inductor of circuit schematic 430, the first (e.g., left) side of equivalent magnetic material 406 includes a first leakage inductance 436 and a first magnetizing inductance 432, and the second (e.g., right) side includes a second leakage inductance 438 and a second magnetizing inductance 434. The values of the first and second leakage and magnetizing inductances are as shown in FIG. 4, where “k” is a coupling factor between L₁₁ and L₂₂. This coupling factor k is equal to the mutual inductance on the second wire from the first wire, divided by the inductance L₂₂.

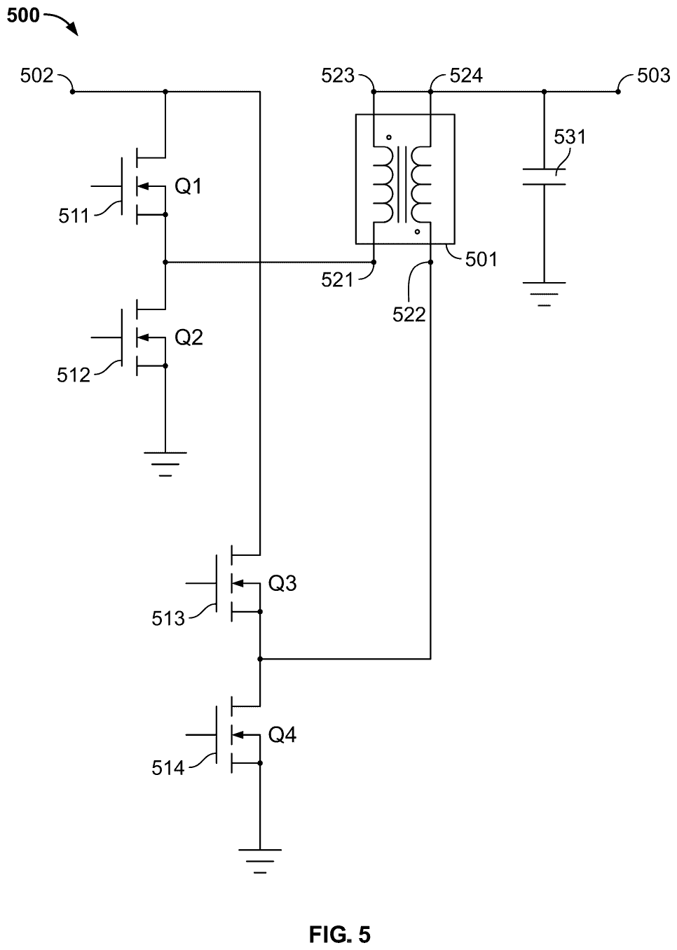

FIG. 5 shows a direct coupling dual-phase power converter circuit 500 including a magnetic flux coupling device 501, in accordance with embodiments of the present disclosure. Magnetic flux coupling device 501 may be any one of magnetic flux coupling devices 100, 200 or 900.

Direct coupling dual-phase power converter circuit 500 is configured for two phases of operation, although it may be configured for any N number of phases, where N is an even integer. In some embodiments, when magnetic flux coupling device 501 is magnetic flux coupling device 100, 900, or a related embodiment thereof, a direct coupling dual-phase power converter circuit 500 includes no more than N/2 magnetic materials. In some embodiments, when magnetic flux coupling device 501 is magnetic flux coupling device 100, 900, or a related embodiment thereof, a direct coupling dual-phase power converter circuit 500 includes more than N/2 magnetic materials (e.g., at least N/2 magnetic materials, including N/2+1 magnetic materials, or any suitable number of magnetic materials).

Magnetic flux coupling device 501 is coupled to first device input 521 (e.g., which may extend from first wire section 130A), second device input 522 (e.g., which may extend from second wire section 140A), first device output 523 (e.g., which may extend from third wire section 130B), and second device output 524 (e.g., which may extend from fourth wire section 140B). First device output 523 and second device output 524 are coupled to each other and to a load (as represented by capacitor 531). Direct coupling dual-phase power converter circuit 500 includes switches Q1 511, Q2 512, Q3 513, and Q4 514 to control how current flows from through the two wires corresponding to the first device input/output and the second device input/output. These switches therefore control how power is converted between converter input 502 and output 503.

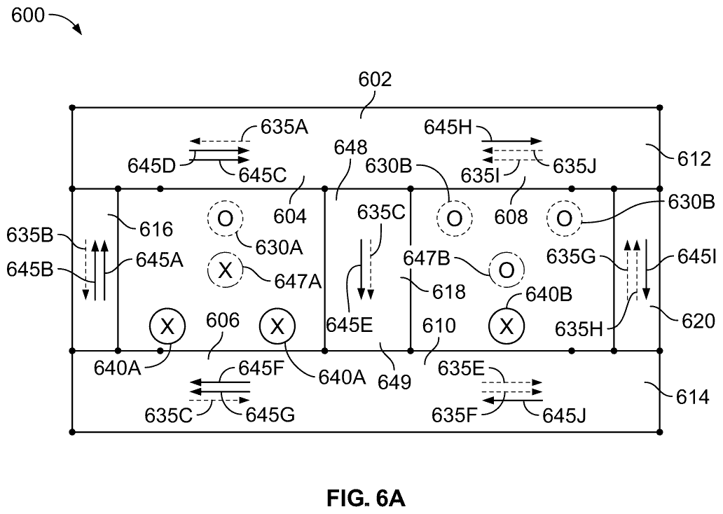

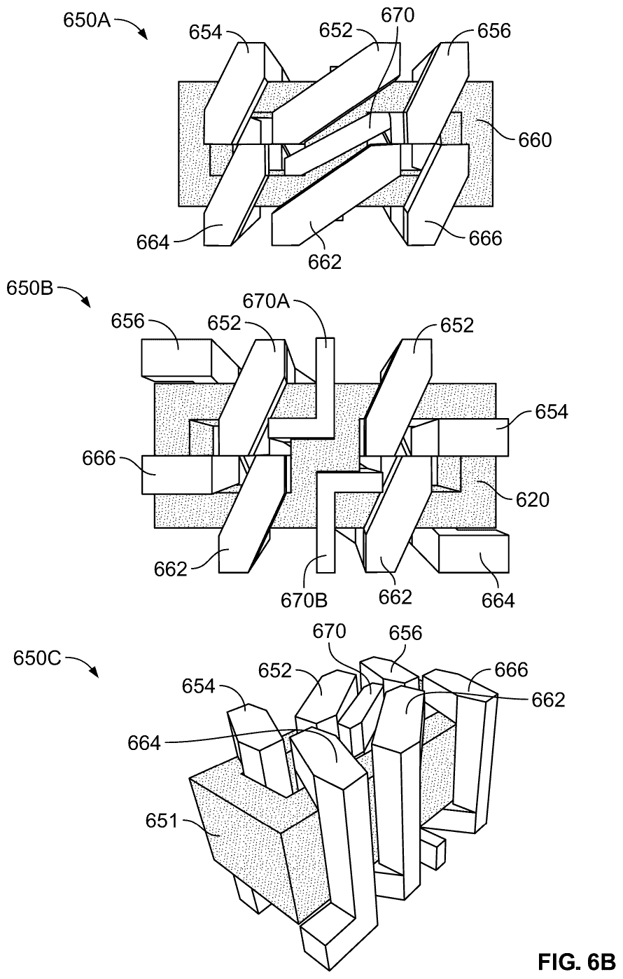

FIG. 6A shows a cross-sectional view of an illustrative third magnetic flux coupling device 600, in accordance with some embodiments of the present disclosure. Third magnetic flux coupling device 600 may be a modified embodiment of first magnetic flux coupling device 100, where the former adds a third wire 647, as further described below. Accordingly, elements 602, 604, 606, 608, 610, 612, 614, 616, 618, 620, 630, 635, 640, and 645 may respectively correspond to elements 102, 104, 106, 108, 110, 112, 114, 116, 118, 120, 130, 135, 140, and 145.

As represented by the dotted-dashed circle, third magnetic flux coupling device 600 also includes a third wire 647, which includes a fifth section 647A and a sixth section 647B. The fifth section 647A is wound around a fifth portion 648 of the magnetic material 601 and the sixth portion 647B is wound around a sixth portion 649 of the magnetic material 601. In some embodiments, the fifth portion 648 and the sixth portion 649 each include a portion of center leg 618. The directions of current flow through the fifth section 647A and the sixth section 647B are denoted using “x” and “o”, as described at least in connection with FIG. 1.

In the third magnetic flux coupling device 600, the degree of electromagnetic coupling (based on interactions with magnetic material 602) between the first wire 630 and the third wire 647 is based on at least a ratio of the third number of windings of the third section 630B over a fifth number of windings of the fifth section 647A. Moreover, the degree of electromagnetic coupling (based on interactions with magnetic material 602) between the second wire 640 and the third wire 647 is based on at least a ratio of the fourth number of windings of the fourth section 640B over a sixth number of windings of the sixth section 647B.

FIG. 6B shows a front view 650A, back view 650B, and side view 650C of the illustrative third magnetic flux coupling device 600, in accordance with embodiments of the present disclosure. FIG. 6B shows how the first wire 630, second wire 640, and third wire 647 are all wound around respective portions of magnetic material 651 (which corresponds to magnetic material 602) and through respective windows in the magnetic material that are enclosed and defined by each of the two gapless magnetic circuits.

The front view 650A shows a second wire (e.g., second wire 640), which includes sections 654, 652, and 656, a first wire (e.g., first wire 630), which includes sections 664, 662, and 666, and a (e.g., third wire 647), which includes section 670. In some embodiments, section 654 and a portion of section 652 may correspond to section 640A; section 664 may correspond to section 630A; section 656 may correspond to section 640B; section 666 and a portion of section 662 may correspond to section 630B; a first portion (e.g., the left side, as shown in view 650A) of section 670 may correspond to section 647A; and a second portion (e.g., the right side, as shown in view 650A) and of section 670 may correspond to section 647B.

The back view 650B and side view 650C show additional details of the sections and portions described in connection with front view 650A and the cross-sectional view of FIG. 6A. Back view 650B shows a back side 620 of the magnetic material 602, which reveals how wire sections 656, 654, 666, 664, 670A, and 670B can provide connections (e.g., input and output connections) to first wire 630, second wire 640, and third wire 647 of magnetic flux coupling device 600. For example, additional sections of the first, second, and third wires, though not being shown, may extend from the ends of sections 656, 654, 666, 664, 670A, and 670B as shown. For another example, the ends of these sections may couple to pins (e.g., of a circuit board), and input/output wires may then couple to the magnetic flux coupling device through the pins. Side view 650C shows how sections 662, 664, and 666 wrap around magnetic material 651 through the respective windows that are enclosed and defined by the first and second gapless magnetic circuits of the magnetic material.

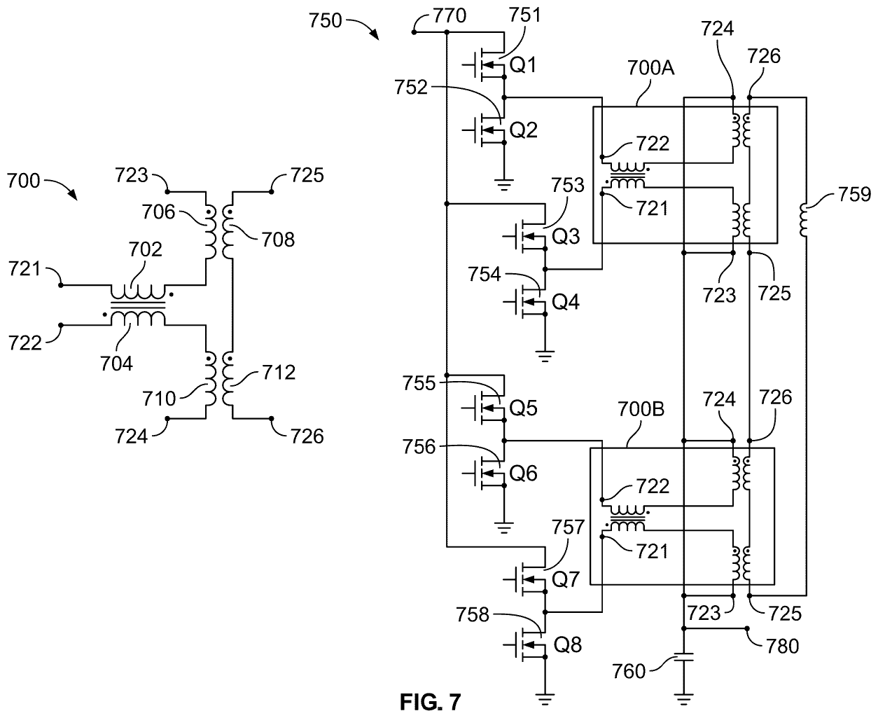

FIG. 7 shows an equivalent circuit 700 for the third magnetic flux coupling device 600, in accordance with some embodiments of the present disclosure. The windings of equivalent circuit 700 (which have corresponding inductances, similar to those shown in connection with circuit schematic 400) include winding 702 (e.g., corresponding to first section 630A), winding 704 (e.g., corresponding to second section 640A), winding 706 (e.g., corresponding to third section 630B), winding 708 (e.g., corresponding to fifth section 647A), winding 710 (e.g., corresponding to fourth section 640B), and winding 712 (e.g., corresponding to sixth section 647B). Each respective winding is directly electromagnetically coupled to one other winding based on how these windings are wound around the magnetic material 602, as depicted by respective pairs of coupled windings being arranged across from each other in equivalent circuit 700. Equivalent circuit 700 includes first and second inputs 721 and 722, which respectively couple to the first section 630A and the second section 640A, first and second outputs 723 and 724, which respectively couple to third section 630B and fourth section 640B, and third and fourth outputs 725 and 726, which respectively couple to fifth section 647A and sixth section 647B.

FIG. 7 also shows an indirect coupling dual-phase power converter circuit 750 including the third magnetic flux coupling device 600 (which is depicted using equivalent circuit 700), in accordance with some embodiments of the present disclosure. Indirect coupling dual-phase power converter circuit 750 is a first illustrative implementation of a coupled inductor plus inductor voltage regulator (CLVR) circuit. Indirect coupling dual-phase power converter circuit 750 includes two of the third magnetic flux coupling devices 600, which are depicted as equivalent circuit 700A and equivalent circuit 700B. Each of these devices has a corresponding four switches, with current flow and power conversion through the former controlled by switches Q1 751, Q2 752, Q3 753, and Q4 754, and current flow and power conversion through the latter controlled by switches Q5 756, Q6 756, Q7 757, and Q8 758.

As shown in FIG. 7, first and second outputs 723 and 724 of both equivalent circuits 700A and 700B are coupled to each other and to a load represented by capacitor 760. Third and fourth outputs 725 and 7t26 of both equivalent circuits 700A and 700B are coupled in series in a loop including coupling inductor 759. Based on this arrangement, winding 702 (e.g., corresponding to first section 630A) and winding 704 (e.g., corresponding to second section 640A) are electromagnetically equivalent to a first transformer, winding 706 (e.g., corresponding to third section 630B) and winding 708 (e.g., corresponding to fifth section 647A) are coupled to each other and to a load, and winding 710 (e.g., corresponding to fourth section 640B) and winding 712 (e.g., corresponding to sixth section 647B) are coupled to the coupling inductor 759. The aforementioned arrangement may precisely control a power conversion operation that occurs between input 770 and output 780 of the indirect coupling dual-phase power converter circuit 750.

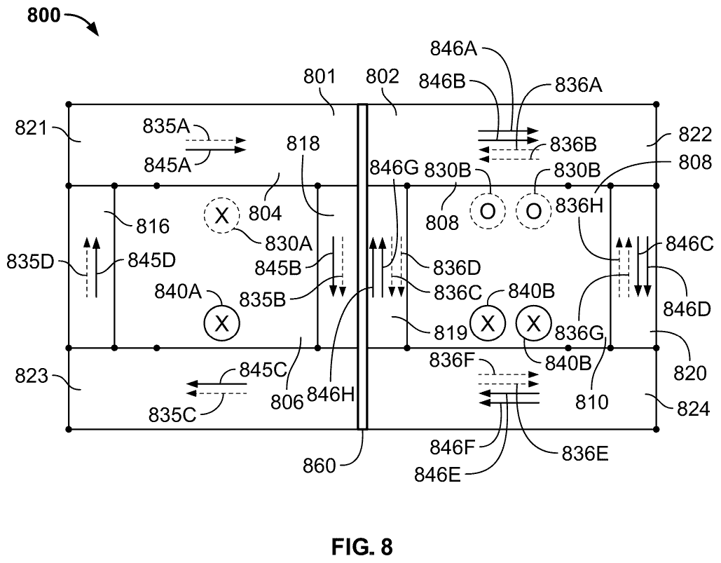

FIG. 8 shows a cross-sectional view of an illustrative fourth magnetic flux coupling device 800, in accordance with some embodiments of the present disclosure. In some embodiments, the fourth magnetic flux coupling device 800 represents an arrangement that corresponds to the equivalent circuit of FIG. 13. The fourth magnetic flux coupling device 800 is similar to the second magnetic flux coupling device 200, except that the former has a different arrangement of wires (e.g., the number of turns associated with some wire sections is different, and the direction of current flow through some winding sections is different). Accordingly, clements 801, 802, 804, 806, 808, 810, 816, 818, 819, 820, 821, 822, 823, 824, and 860 may respectively correspond to elements 201, 202, 204, 206, 208, 210, 216, 218, 219, 220, 221, 222, 223, 224, and 260.

Fourth magnetic flux coupling device 800 as shown in FIG. 8 has a first wire 830 and a second wire 840. The first section 830A of first wire 830 includes a first number of windings and the second section 840A of second wire 840 includes the same first number of windings. Moreover, the direction of the current flow through the first section 830A aligns with a direction of the current flow through the second section 840B (as indicated by the respective “x” markers) to achieve the polarity reversal that occurs when transferring power across the bottom windings of FIG. 13. In contrast, the direction of current flow through the third section 830B of first wire 830 opposes a direction of the current flow through the fourth section 840B of second wire 840. These oppositely oriented current flows maintain the polarity when transferring power across the bottom windings of FIG. 13.

Fourth magnetic flux coupling device 800 includes a partition 860 between the first magnetic material 801 and the second magnetic material 802 at least because flux line 835B would not cancel with flux lines 846C and 846D.

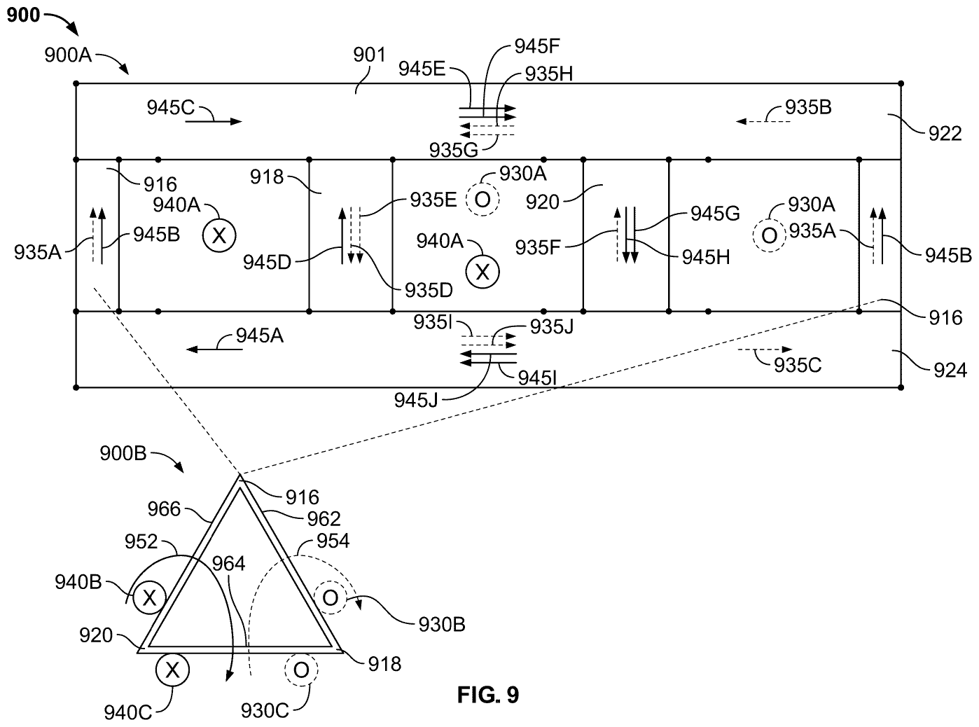

FIG. 9 shows two cross-sectional views of an illustrative fifth magnetic flux coupling device 900, in accordance with some embodiments of the present disclosure. View 900A shows an unraveled cross-sectional depiction, where the left-most and the right-most leg are the same leg, as indicated by the consistent labeling of leg 916, and the cross-section is shown in this unraveled perspective to illustrate the relevant wire configurations and gapless magnetic circuits. View 900B shows a top-down cross-section that is more indicative of the true triangular geometry of fifth magnetic flux coupling device 900. For example, the unraveled geometry shown in view 900A collapses or ravels into the geometry shown in 900B when connecting third leg 916 in a first gapless magnetic circuit including first leg 918 and when further connecting third leg 916 in a second gapless magnetic circuit including second leg 920.

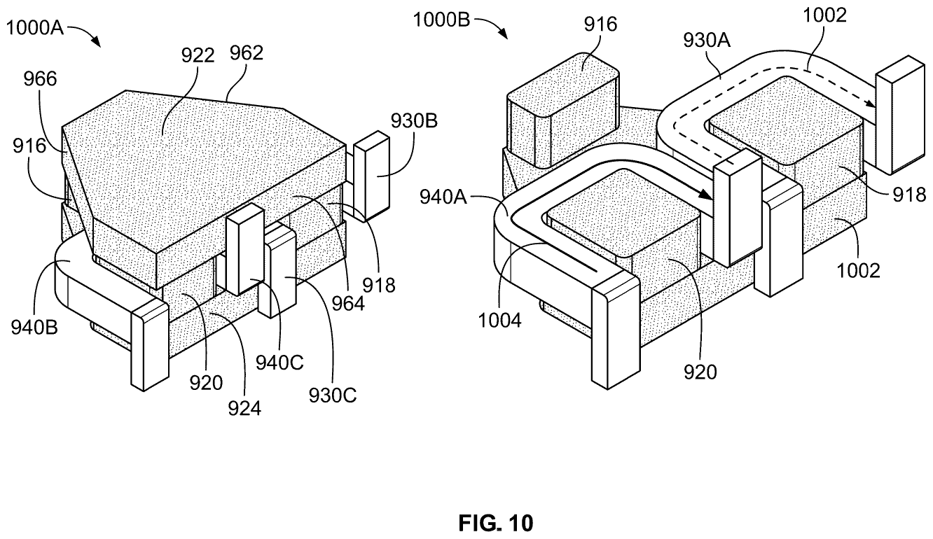

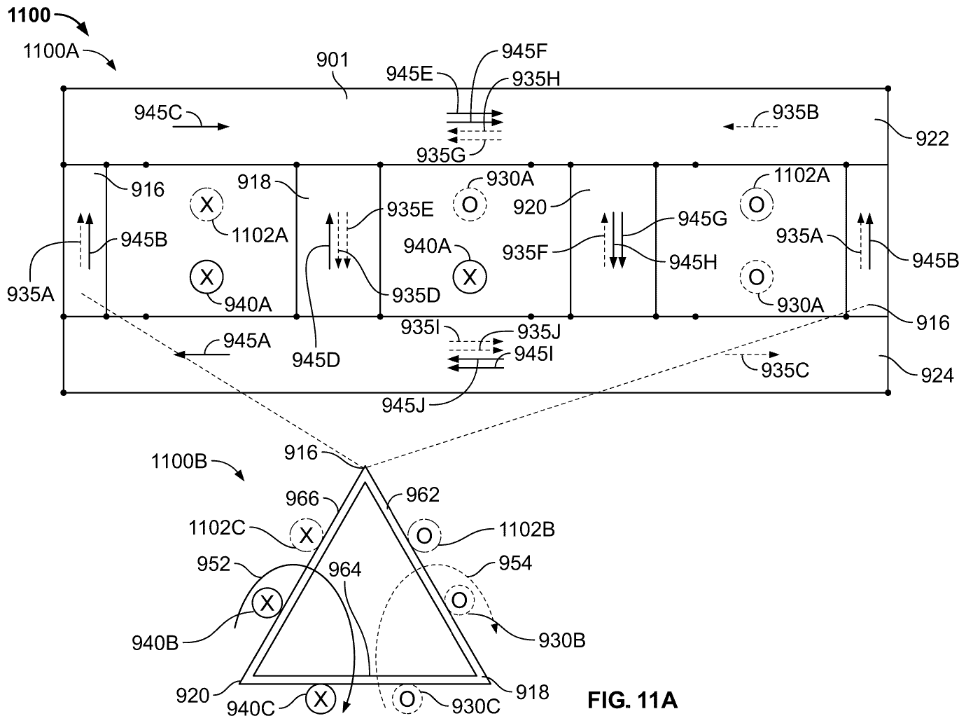

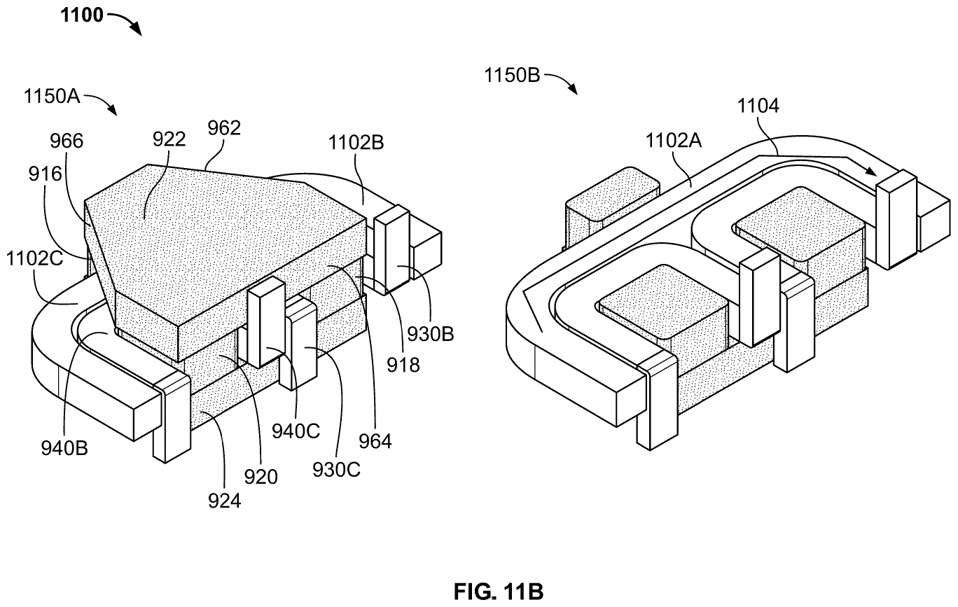

Fifth magnetic flux coupling device includes magnetic material 901, which includes a top plane 922 and a bottom plane 924. Each of the top plane 922 and the bottom plane 924 include a first primary side 962, a second primary side 964, and a third primary side 966 (e.g., where view 900B may show, from the top-down, primary sides of the top plane 922, or alternatively it may show, from the bottom-up, primary sides of the bottom plane 924). The aforementioned sides are denoted as primary sides because the triangular geometry as shown in view 900B may, in practice, have flat-edged corners (e.g., as shown at least in connection with FIGS. 10 and 11A) rather than corners with sharp points (e.g., as shown in view 900B). Whether fifth magnetic flux coupling device 900 has sharp corners or flat-edged corners, arrangements are provided herein for controlling magnetic flux coupling based at least in part on use of the aforementioned three primary sides.

As shown in view 900A, legs 916, 918, and 920 are each directly coupled to the top plane 922 and the bottom plane 924 to form two gapless magnetic circuits. The first gapless magnetic circuit includes leg 916, leg 918, top plane 922, and bottom plane 924; the second gapless magnetic circuit includes leg 916, leg 920, top plane 922, and bottom plane 924. As shown in view 900B, the first leg 918 extends from a junction between the first primary side 962 and the second primary side 964; the second leg 920 extends from a junction between the second primary side 964 and the third primary side 966; and the third 916 extends from a junction between the first primary side 962 and the third primary side 966.

Fifth magnetic flux coupling device 900 also includes first wire 930, including a first section 930A wound around the first leg 918, and second wire 940, including a second section 940A wound around the second leg 920. When current flows through the first wire 930 and the second wire 940, a degree of electromagnetic coupling, based on interactions with the at least one magnetic material 901, between the first wire and the second wire is based on at least a ratio of a first number of windings of the first section 930A over a second number of windings of the second section 940A. In some embodiments, the direction of current flow through first wire 930 opposes the direction of current flow through second wire 940, as shown by the respective ‘x’ and ‘o’ current flow directions (e.g., as described at least in connection with FIG. 1).

The arrangement of the fifth magnetic flux coupling device 900 causes the flux lines 935 and 945 to flow through the two gapless magnetic circuits as shown. In some embodiments, the first leg 918, second leg 920, and third leg 916 are arranged such that when the current flows through the first wire 930 and the second wire 940, the first leg and the second leg cancel magnetic flux of the first gapless magnetic circuit (e.g., including flux lines 935A-E, and flux lines 945A-D) with magnetic flux of the second gapless magnetic circuit (e.g., including flux lines 935D-J, and flux lines 945D-J).

View 900B shows how first wire 930 includes fourth section 930B and fifth section 930C, which extend from first primary side 962 and second primary side 964, respectively; and second wire 940 includes sixth section 940B and seventh section 940C, which extend from second primary side 964 and third primary side 966, respectively.

FIG. 10 shows perspective view 1000A and cutout view 1000B of the illustrative fifth magnetic flux coupling device 900, in accordance with some embodiments of the present disclosure. Perspective view 1000A shows a three-dimensional arrangement corresponding to the cross-sectional views of FIG. 9. The fourth section 930B, fifth section 930C, sixth section 940B, and seventh section 940C may be used to couple additional wires or pins to the fifth magnetic flux coupling device 900; otherwise, the first wire 930 may extend from the fourth and/or fifth sections, and the second wire 940 may extend from the sixth and/or seventh sections.

Cutout view 1000B shows perspective view of 1000A with the top plane 922 removed to reveal additional details of how first section 930A winds around first leg 918, and how second section 940A winds around second leg 920. The first current flow direction 1002 through first wire 930 and the second current flow direction 1004 through second wire 940 are annotated for clarity and consistent with the current flow directions shown in FIG. 9.

FIG. 11A shows cross-sectional views 1100A and 1100B of an illustrative sixth magnetic flux coupling device 1100, in accordance with some embodiments of the present disclosure. The sixth magnetic flux coupling device 1100 corresponds to modifying the fifth magnetic flux coupling device 900 to include a third wire 1102. With respect to the first section 930A of first wire 930, and the second section 940B of second wire 940, the third wire 1102 includes a third section 1102A that is wound around the first leg 918 and the second leg 920 (e.g., as further shown in FIG. 11B). Based on this arrangement, when current flows through the first wire 930, the second wire 940, and the third wire 1102, a degree of electromagnetic coupling, based on interactions with the at least one magnetic material 901, between the first wire and the third wire is based on at least a ratio of the first number of windings of the first section 930A over a third number of windings of the third section 1102A, and a degree of electromagnetic coupling, based on interactions with the at least one magnetic material, between the second wire and the third wire is based on at least a ratio of the second number of windings of the second section 930A over the third number of windings of the third section 1102.

View 1100B shows how third wire 1102 includes eighth section 1102B and ninth section 1102C, which extend from first primary side 962 and third primary side 966, respectively. The eighth section 1102B and ninth section 1102C may be used to couple additional wires or pins to the sixth magnetic flux coupling device 1100; otherwise, the third wire 1102 may extend from the eighth and/or ninth sections.

FIG. 11B shows perspective view 1150A and cutout view 1150B of the illustrative sixth magnetic flux coupling device 1100, in accordance with some embodiments of the present disclosure. Perspective view 1150A shows a three-dimensional arrangement corresponding to the cross-sectional views of FIG. 11A. Cutout view 1150B shows perspective view of 1150A with the top plane 922 removed to reveal additional details of how third section 1102A winds around first leg 918 and second leg 920. The first current flow direction 1104 through third wire 1104 is annotated for clarity and consistent with the current flow direction shown in FIG. 11A.

It is noted that sixth magnetic flux coupling device 1100 may be characterized using the equivalent circuit 700. Accordingly, first input 721 and first output 723 may respectively correspond to the terminal regions of fourth section 930B and fifth section 930C; second input 722 and second output 724 may respectively correspond to the terminal regions of sixth section 940B and seventh section 940C; and third output 725 and fourth output 726 may respectively correspond to the terminal regions of eighth section 1102B and ninth section 1102C. Moreover, windings 702 and 706 may correspond to electromagnetic interactions between first section 930A and magnetic material 901 (e.g., based on coupling with top plane 922 and bottom plane 924); windings 704 and 710 may correspond to electromagnetic interactions between second section 940A and magnetic material 901 (e.g., based on coupling to top plane 922 and bottom plane 924); and windings 708 and 712 may correspond to electromagnetic interactions between third section 1102A and magnetic material 901 (e.g., based on coupling to top plane 922 and bottom plane 924). Similarly, it is noted that indirect coupling dual-phase power converter circuit 750 may include, at 700A and/or 700B, sixth magnetic flux coupling device 1100.

To illustrate additional details of various arrangements of magnetic flux coupling devices as described above, FIG. 12 shows an equivalent circuit corresponding to a magnetic flux coupling device that uses a transformer to control magnetic flux coupling. In some embodiments of the equivalent circuit shown in FIG. 12, N₂ is less than one; or equivalently, the turns ratio may be expressed as N₂:1. In these embodiments, the corresponding magnetic flux coupling device may operate as a step down transformer.

To illustrate additional details of various arrangements of magnetic flux coupling devices as described above, FIG. 13 shows another equivalent circuit corresponding to a magnetic flux coupling device that uses a transformer to control magnetic flux coupling. In some embodiments, the corresponding magnetic flux coupling device may operate as a step down transformer. As shown by the dot orientation of FIG. 13, the respective polarities of power transfer may be different across the two gapless magnetic circuits (e.g., to at least in part control whether power transfer across the transformer is positively or reverse coupled).

With regard to at least wires, current flows, and magnetic flux lines, the term “coupled to” may indicate that two or more components are electromagnetically connected to each other (e.g., based on how flowing current may induce or be influenced by a magnetic field). Wires that are coupled to or with each other need not be directly coupled to or with each other. Devices that are coupled to or with each other may be coupled directly or indirectly (e.g., where two wires may be coupled through a magnetic material). Relatedly, the term “interactions” (e.g., as is used with respect to electromagnetic coupling) may refer how a magnetic field influences current flow, or vice versa, due to components being coupled to each other.

With regard to at least top planes, bottom planes, and legs, the term “coupled to” may indicate that two or more components are physically attached to each other.

The terms “input” and “output” may be used to characterize portions of a circuit. It will be understood that these characterizations are merely for the purpose of illustrating some embodiments of the present disclosure. An input may serve as an output, and vice versa. Either one of an input or an output may be coupled to additional circuitry that is not shown, including a source or a load, without changing the function of the circuit as shown or the related teachings.

It is noted that while specific arrangements of windings and number of turns are disclosed herein, the teachings of this disclosure may be applied to deices with any two or more gapless magnetic circuits, where each gapless magnetic circuit has at least two wires coupled to the magnetic material of the gapless magnetic circuit.

The foregoing description of various embodiments has been presented for the purposes of illustration and description. It is not intended to be exhaustive or to be limited to the precise forms disclosed. Many modifications and variations are possible in light of the above teaching.

What is claimed is:

1. A device comprising:
at least one magnetic material comprising:
a top plane,
a bottom plane, and
at least three legs, all of which are directly coupled to the top plane and to the bottom plane to define a first portion, a second portion, a third portion, and a fourth portion of the at least one magnetic material and to form two gapless magnetic circuits;
a first wire comprising:
a first section wound around the first portion, and
a third section wound around the third portion; and
a second wire comprising:
a second section wound around the second portion, and
a fourth section wound around the fourth portion;
such that when a current flows through the first wire and the second wire, a degree of electromagnetic coupling, based on interactions with the at least one magnetic material, between the first wire and the second wire is based on at least a ratio of a first number of windings of the first section over a second number of windings of the second section.

2. The device of claim 1, wherein the degree of the electromagnetic coupling is further based on a ratio of a fourth number of windings of the fourth section over a third number of windings of the third section.

3. The device of claim 1, wherein:
the first section and the second section are arranged as a first transformer; and
the third section and the fourth section are arranged as a second transformer.

4. The device of claim 3, wherein the first transformer and the second transformer are electromagnetically equivalent to a coupled inductor, and the degree of electromagnetic coupling is further based on an inductance of the first wire and an inductance of the second wire.

5. The device of claim 1, wherein the at least one magnetic material comprises a first magnetic material and a second magnetic material, wherein the first magnetic material comprises the first portion and the second portion and the second magnetic material comprises the third portion and the fourth portion.

6. The device of claim 1, wherein the at least one magnetic material comprises a single magnetic material, wherein each of the two gapless magnetic circuits comprises at least one portion of the top plane, at least one portion of the bottom plane, and exactly two of the three legs.

7. The device of claim 6, wherein the three legs comprise a center leg arranged between first and second legs, wherein when the current flows through the first wire and the second wire, the center leg cancels magnetic flux of a first magnetic circuit of the two gapless magnetic circuits with magnetic flux of a second magnetic circuit of the two gapless magnetic circuits.

8. The device of claim 1, wherein the at least one magnetic material further comprises a fifth portion and a sixth portion, the device further comprising a third wire comprising:
a fifth section wound around the fifth portion; and
a sixth section wound around the sixth portion.

9. The device of claim 8, wherein:
the degree of electromagnetic coupling, based on interactions with the at least one magnetic material, between the first wire and the third wire is based on at least a ratio of the third number of windings over the fifth number of windings.

10. The device of claim 9, wherein:
the degree of electromagnetic coupling, based on interactions with the at least one magnetic material, between the second wire and the third wire is based on at least a ratio of the fourth number of windings over the sixth number of windings.

11. The device of claim 1, wherein the first wire and the second wire are arranged such that:
when the current flows through the first wire and the second wire, a direction of the current flow through the first section opposes a direction of the current flow through the second section, and a direction of the current flow through the third section opposes a direction of the current flow through the fourth section.

12. The device of claim 1, wherein the first wire and the second wire are arranged such that:
when the current flows through the first wire and the second wire, a direction of the current flow through the first section aligns with a direction of the current flow through the second section, and a direction of the current flow through the third section opposes a direction of the current flow through the fourth section.

13. A device comprising:
a magnetic material comprising:
a top plane comprising a first primary side, a second primary side, and a third primary side,
a bottom plane comprising corresponding first, second, and third primary sides,
three legs, all of which are directly coupled to the top plane and to the bottom plane to form two gapless magnetic circuits, wherein:
a first leg of the at least three legs extends from a junction between the first primary side and the second primary side,
a second leg of the at least three legs extends from a junction between the first primary side and the third primary side, and
a third leg of the at least three legs extends from a junction between the second primary side and the third primary side;
a first wire comprising a first section wound around the first leg; and
a second wire comprising a second section wound around the second leg;
such that when current flows through the first wire and the second wire, a degree of electromagnetic coupling, based on interactions with the at least one magnetic material, between the first wire and the second wire is based on at least a ratio of a first number of windings of the first section over a second number of windings of the second section.

14. The device of claim 13, wherein the first, second, and third legs are arranged such that when the current flows through the first wire and the second wire, the first leg and the second leg cancel magnetic flux of a first magnetic circuit of the two gapless magnetic circuits with magnetic flux of a second magnetic circuit of the two gapless magnetic circuits.

15. The device of claim 13, further comprising a third wire comprising a third section wound around the first leg and the second leg, such that when current flows through the first wire, the second wire, and the third wire:
a degree of electromagnetic coupling, based on interactions with the at least one magnetic material, between the first wire and the third wire is based on at least a ratio of the first number of windings of the first section over a third number of windings of the third section; and
a degree of electromagnetic coupling, based on interactions with the at least one magnetic material, between the second wire and the third wire is based on at least a ratio of the second number of windings of the second section over the third number of windings of the third section.

16. A coupled inductor plus inductor voltage regulator (CLVR) circuit configured for N phases of operation, wherein N is an even integer greater than 1, the circuit comprising:
at least N/2 magnetic materials, wherein at least two wires are wound around each of the magnetic materials, and each of the magnetic materials comprises:
a top plane,
a bottom plane, and
at least three legs, all of which are directly coupled to the top plane and to the bottom plane to define a first portion, a second portion, a third portion, and fourth portion of the magnetic material and to form two gapless magnetic circuits;
a first wire of the at least two wires, the first wire comprising a first section wound around the first portion and a third section wound around the third portion; and
a second wire of the at least two wires, the second wire comprising a second section wound around the second portion and a fourth section wound around the fourth portion.

17. The CLVR circuit of claim 16, wherein respective outputs of the third section and the fourth section are coupled to each other and are coupled to a load.

18. The CLVR circuit of claim 16, further comprising a plurality of switches to control current flows through the at least two wires.

19. The CLVR circuit of claim 16, wherein the at least one magnetic material further comprises a fifth portion and a sixth portion, the CLVR circuit further comprising:
a third wire of the at least two wires, the third wire comprising a fifth section wound around the fifth portion and a sixth section wound around the sixth portion.

20. The CLVR circuit of claim 19, further comprising a coupling inductor, wherein:
the first section and the second section are electromagnetically equivalent to a first transformer;
respective outputs of the third section and the fourth section are coupled to each other and to a load; and
respective outputs of the fifth section and the sixth section are coupled to the coupling inductor.
